(19) United States
(12) Patent Application Publication
(10) Pub. No.: US 2009/0092248 A1
(43) Pub. Date: Apr. 9, 2009

(54) ENCRYPTION-BASED AUTHENTICATION FOR BINDING MODULES

(75) Inventor: Andrew R. Rawson, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/867,071

(22) Filed: Oct. 4, 2007

(51) Int. Cl. H04L 9/14; G06Q 10/00; H04L 9/32

(52) U.S. Cl. 380/45; 705/1; 713/169

(57) ABSTRACT

A first electronic module authenticates a second electronic module via encrypted communications between the first electronic module and the second electronic module. In response to determining the second electronic module is authenticated, the first electronic module is configured to conduct unencrypted communications with the second electronic module. Otherwise, in response to determining the second electronic module is unauthenticated, the first electronic module is configured to disable one or more functions of the first electronic module.

### FIELD OF THE DISCLOSURE

The present disclosure relates generally to interactions between electronic modules of a system and more particularly to preventing unauthorized use of electronic modules of a system via binding.

### BACKGROUND

Manufacturers and other providers of electronic systems often find it desirable to restrict, or “bind,” the interoperability of modules of the electronic system to only those modules in the same electronic system or alternately to only those modules of an identified class of components. To illustrate, a provider may supply an electronic system to an end user at a price less than it cost to manufacture the electronic system with an intent to recoup its subsidy, i.e. the difference in price and cost, through services, upgrades, or modifications offered in conjunction with the electronic device. By configuring the modules of the electronic system to interact only with other modules of the same electronic system, providers can discourage the purchasing the electronic system with the intent to dismantle and sell the individual modules of the electronic system, which would render the electronic system inoperable and therefore eliminate the ability of the provider to recoup its subsidy in the electronic system through subsequent services, modifications, or upgrades.

Typically, binding modules in an electronic system involves configuring the modules so that all external communications are encrypted using a key or key pair implemented at all of the involved components of the same electronic system. Thus, the use of a module so configured in another electronic system likely would fail as the other components of the other electronic system would unable to recover the encrypted communications from, and provide properly encrypted communications to, the introduced module. However, encryption/decryption processes are time-intensive and processing-intensive tasks, and thus the encryption and decryption of all communications between bound modules can unnecessarily limit the bandwidth of the bound modules and increase the power consumed by the bound modules. Accordingly, an improved technique for binding modules in an electronic system would be advantageous.

### BRIEF DESCRIPTION OF THE DRAWINGS

The present disclosure may be better understood and its numerous features and advantages made apparent to those skilled in the art by referencing the accompanying drawings. The use of the same reference symbols in different drawings indicates similar or identical items.

FIG. 1 is a diagram illustrating a successful binding process for a first electronic module and a second electronic module in accordance with at least one embodiment of the present disclosure.

FIG. 2 is a diagram illustrating an unsuccessful binding process between a first electronic module and a second electronic module in accordance with at least one embodiment of the present disclosure.

FIG. 3 is a diagram illustrating another unsuccessful binding process between a first electronic module and a second electronic module in accordance with at least one embodiment of the present disclosure.

FIG. 4 is a block diagram depicting an electronic module utilizing an encryption-based binding technique in accordance with at least one embodiment of the present disclosure.

FIG. 5 is a flow diagram depicting a method for binding a first electronic module and a second electronic module in accordance with at least one embodiment of the present disclosure.

FIG. 6 is a block diagram illustrating an example implementation of an electronic module utilizing an encryption-based binding technique in accordance with at least one embodiment of the present disclosure.

FIG. 7 is a flow diagram depicting an example operation of the electronic module of FIG. 6 in accordance with at least one embodiment of the present disclosure.

### DETAILED DESCRIPTION

The present disclosure illustrates example techniques for binding electronic modules by enabling or restricting communications between the electronic modules or by enabling or disabling other functionality of the electronic modules based on a result of an encryption-based authentication process. In one embodiment, a first electronic module initiates an encryption-based authentication process with a second module. If the authentication is successful the first electronic module enables certain functions related to the second electronic module, such as the function of conducting unencrypted communications with the second module. Conversely, if the first electronic device fails to authenticate the second electronic module, certain functions of the first electronic module are disabled or are defaulted to a lower level of operation. A lower level of operation can include, for example, limiting the processing speed, reducing the communication bandwidth, or the like. The functions that can be disabled can include, for example, unencrypted communications with the second electronic module, certain processing functionality, or the like. By configuring electronic components to utilize encryption for the authentication process while allowing unencrypted communications after successful authentication, the bandwidth of the electronic modules can be increased and their power consumption decreased compared to conventional systems whereby all communications are subjected to the encryption process in an effort to prevent unauthorized use.

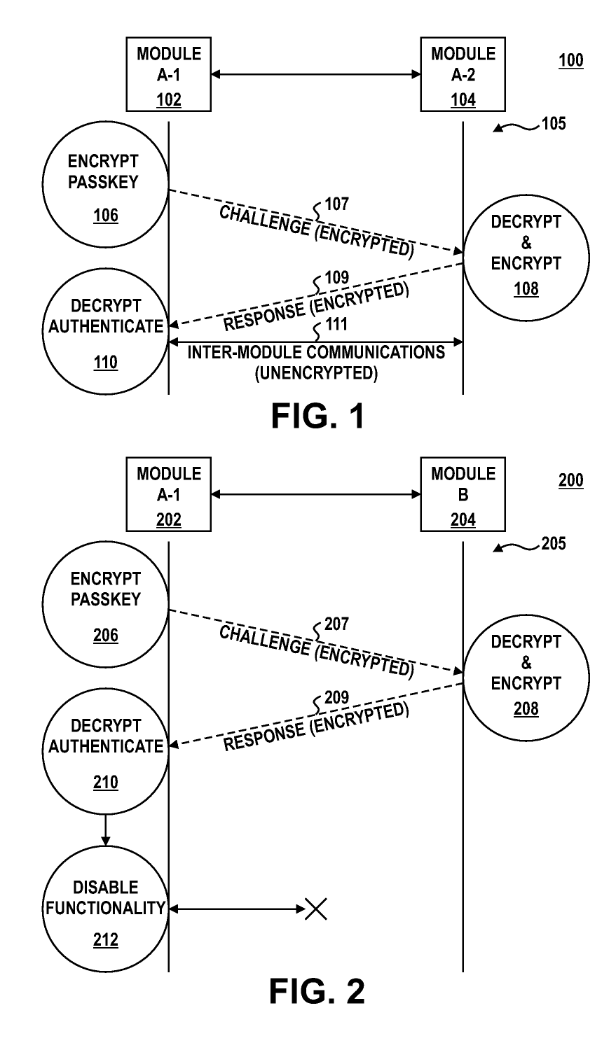

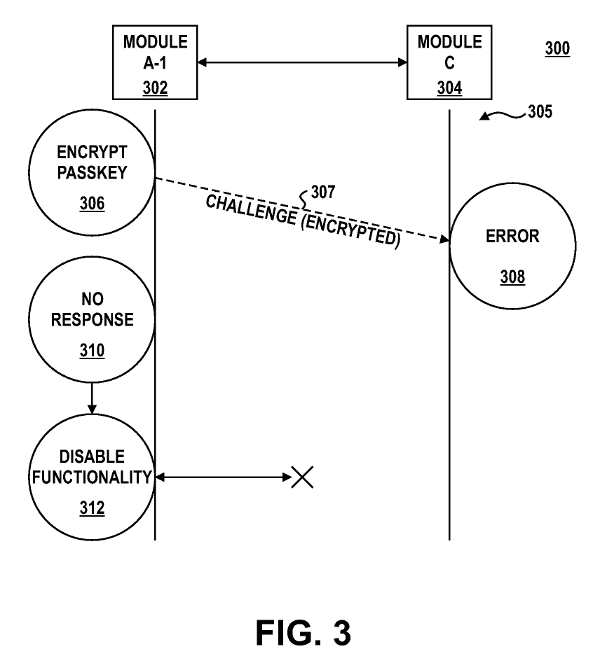

FIGS. 1-3 illustrate various binding processes between two electronic modules in accordance with at least one embodiment of the present disclosure. In particular, FIG. 1 illustrates a successful binding process from one electronic module to another electronic module, both of which are configured to implement an encryption-based authentication process and are configured to bind to each other based on their implementation of a corresponding key set. FIG. 2 illustrates an unsuccessful binding process between two electronic modules that are both configured to implement an encryption-based authentication process but are configured with incompatible key sets. FIG. 3 illustrates an unsuccessful binding process between two electronic modules whereby one of the electronic modules is not configured to implement an encryption-based authentication process.

Each of the examples illustrated in FIGS. 1-3 demonstrate one electronic module authenticating another electronic module. The other electronic module then can repeat this process to authenticate the first electronic module so as to achieve mutual authentication, or mutual binding. By performing mutual authentication, both modules can be configured to disable a set of functionality or default to a lower level of operation when the authentication process fails. Alternately, both electronic modules can be configured to enable certain functionality, such as unencrypted communications, when the authentication is successful. Such an operation has the ability to enable unencrypted bidirectional communication to between electronic modules. The process of mutual authentication can occur substantially simultaneously, independently, in a specified order, or the like.

In one embodiment, electronic modules as illustrated in FIGS. 1-3 can be discrete electronic modules, such as a CPU, north bridge, and south bridge, within a processor motherboard. Alternately, an electronic module itself may be a collection of electronic components that define a single unit, such as a notebook computer, a portable electronic device (e.g., a cell phone), and the like. Often, in such products, an electronic system is provided for a price less that the collective market value of its individual electronic modules. For such systems, the provider may attempt to discourage the resale of the electronic modules individually by configuring the electronic modules to operate only with each other. A binding process to control the interaction between electronic modules using an encryption-based authentication process, whereby unencrypted communications are enabled when the authentication succeeds or for which functionality is reduced when it fails can be used to discourage dismantling with the intent to sell the individual modules of the electronic system. Alternately, the interoperability between electronic modules can be restricted to a specified set or class to encourage the purchase of the set of electronic modules provided by a manufacture. For example, a manufacture may produce a laptop and a docking bay, and may desire to discourage the sale of other docking bays produced by other manufactures that attempt to operate with the laptop. By having one or more electronic modules authenticate each other using an encryption-based authentication, the interaction and communication between electronic modules can be restricted to operate with an authorized set of electronic modules.

The encryption-based authentication process described can be used to restrict the communication from one device to only a specific subset of other devices. For instance, a laptop docking bay may be made to interoperate with only a specific laptop or a specific set of laptops. The docking station is disabled from operating with any laptop out of the specified set, but unencrypted communication of the communication interface between the docking station and the laptop if enabled if the encryption-based authentication process succeeds.

In the example electronic system 100 illustrated by FIG. 1, an electronic module 102 attempts to authenticate an electronic module 104. In this example, the electronic modules 102 and 104 belong to the same class (class A) and therefore are configured to interoperate with each other; thus electronic module 102 and electronic module 104 are also identified in FIG. 1 as module A-1 and module A-2, respectively.

As illustrated by the binding process chart 105, the electronic module 102 encrypts an identified passkey using a first key at stage 106 and transmitting the encrypted passkey as a challenge 107 to the electronic module 104. At stage 108 the challenge 107 is received by the electronic module 104, which decrypts the challenge 107 using a second key and encrypts the decrypted challenge using a third key to generate a response 109. The response 109 is transmitted to the electronic module 102 and, at stage 110, the electronic module 102 decrypts the response 109 using a fourth key. Further at stage 110, the electronic module 102 compares the decrypted response with the identified passkey used at stage 106. In the event of a sufficient match, the electronic module 102 identifies the electronic module 104 as authenticated and therefore enables certain functionality related to the second electronic module 102. In the illustrated example, the functionality includes disabling the encryption component of the electronic module 102 for communications to be sent to the electronic module 104, thereby enabling unencrypted inter-component communications 111 with the encryption module 104. The electronic module 104 can use the same encryption-based process to authenticate the electronic module 102.

In one embodiment, the electronic modules 102 and 104 are configured for symmetric encryption in that the first key used for encryption by the electronic module 102 and the second key used for decryption by the electronic module 104 are the same key. Likewise, the third key for encryption by the electronic module 104 is the same key as the fourth key used for decryption by the electronic module 102. Alternately, an asymmetric encryption scheme can be used, whereby first and second keys are one encryption key pair (e.g., a public key-private key pair) and the third and fourth keys are another encryption key pair.

In the example of FIG. 1, the electronic modules 102 and 104 use the same keys, or, alternately, corresponding keys of an encryption key pair. Accordingly, the electronic module 104 is able to correctly decrypt the challenge 107 to obtain the original passkey, from which the response 109 is generated, and the electronic module 102 is able to correctly decrypt the response 109 to obtain the original passkey, and thus the comparison reveals a sufficient match to allow the electronic module 102 to authenticate the electronic module 104.

In the example electronic system 200 illustrated by FIG. 2, an electronic module 202 attempts to authenticate an electronic module 204. The electronic module 202 and the electronic module 204 each is configured to support the encryption-based authentication process described above with reference to FIG. 1. However, in this example, the electronic module 202 belongs to one class (class A) with one set of keys and the electronic module 204 belongs to another class (class B) with a different set of keys and the electronic modules 202 and 204 therefore are unable to authenticate each other.

As illustrated by the binding process chart 205, the electronic module 202 encrypts an identified passkey using a first key at stage 206 and transmitting the encrypted passkey as a challenge 207 to the electronic module 204. At stage 208 the challenge 207 is received by the electronic module 204, which decrypts the challenge 207 using a second key and encrypts the decrypted challenge using a third key to generate a response 209. The response 209 is transmitted to the electronic module 202 and, at stage 210, the electronic module 102 decrypts the response 209 using a fourth key. Further at stage 210, the electronic module 202 compares the decrypted response with the identified passkey used at stage 206. In the example of FIG. 2, the electronic module 202 belongs to a different class than the electronic module 204 and thus the electronic module 202 is configured with a set of keys that are incompatible with the set of keys configured for the electronic module 202. Accordingly, when the electronic module 204 decrypts the challenge 207 at stage 208, rather than obtaining the original passkey, a different value is obtained. As the response 209 is not generated from the original passkey due to the incompatible keys, when the electronic module 202 decrypts the response 209 and compares the results with the original passkey, the electronic module 202 will determine there is an insufficient match and, at stage 212, the electronic module 202 therefore disables functionality so as to prevent binding with the unauthenticated electronic device 204. The disabled functionality can include, for example, preventing the encryption components of the electronic device 102 from operating in a clear (unencrypted mode), thereby preventing the electronic module 204 from being able to correct interpret communications output by the electronic module 202, as well as preventing the electronic module 202 from interpreting communications from the electronic device 204.

In the example electronic system 300 illustrated by FIG. 3, an electronic module 302 attempts to authenticate an electronic module 304. The electronic module 302 is configured to support the encryption-based authentication process described above with reference to FIG. 1. However, in this example, the electronic module 304 is not configured to support the encryption-based authentication process.

As illustrated by the binding process chart 305, the electronic module 302 encrypts an identified passkey using a first key at stage 306 and transmits the encrypted passkey as a challenge 307 to the electronic module 304. Because the electronic module 304 is not configured to decrypt the challenge 307 and respond with an encrypted response, at state 308 the electronic device 304 interprets the challenge 307 as an error or as an unrelated communication. At stage 310, the electronic module 102 waits for a response from the electronic module 304, which is does not occur. Failing to receive a response from the electronic module 304 by the expiration of a timer, the electronic module 302 disables functionality at stage 312 so as to prevent binding with the unauthenticated electronic device 304.

In each of the examples depicted above, the authentication process can be initiated in response to a reset condition or a power-on condition, in response to a query from another electronic module, in response to the initiation of an authentication process by another electronic module, in a periodic manner, or the like. If the authentication fails, in one embodiment the disabled functionality remains disabled until the occurrence of another event for which the authentication process succeeds.

In the examples illustrated at FIGS. 1-3, there are only two electronic modules present. However, when there is a plurality of electronic modules, the authentication process may occur via a “star” mode, a “spoke” mode, or a “chain” mode, or the like. A star mode authentication scheme involves each electronic module authenticating with each other electronic module in the system. Conversely, the spoke method has a central electronic module, whereby only the central electronic module authenticates with each of the other electronic modules. In a chain mode, electronic modules authenticate from one to the next until the initial electronic module is reached again. To aid the authentication of a plurality of electronic modules with one another, the electronic modules can authenticate in a transitive fashion, whereby a second electronic module automatically authenticates each electronic module already authenticated by a first electronic module when the second electronic module authenticates the first electronic module. Accordingly, a bus or other interconnect can be used to transmit authentication confirmation information among the electronic modules of a system. Other methods to authenticate a plurality of electronic modules can be implemented using the guidelines provided herein without departing from the scope of the present disclosure.

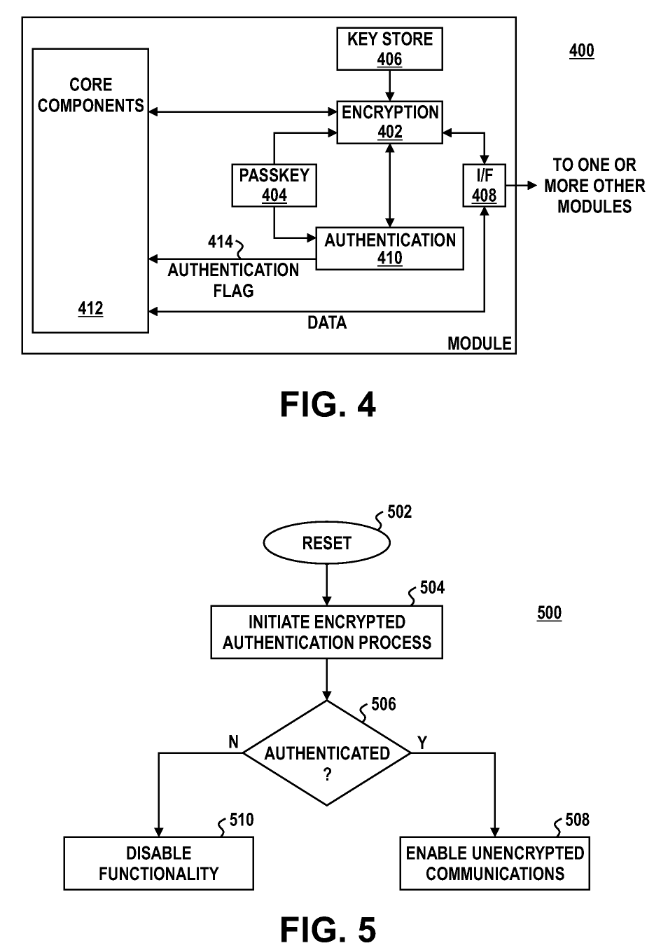

FIG. 4 illustrates an example implementation of an electronic module 400 configured for encryption-based authentication in accordance with at least one embodiment of the present disclosure. The electronic module 400 can correspond to, for example, the electronic modules 102, 104, 202, 204, or 302 of FIGS. 1-3.

In the example depicted, the electronic module 400 comprises an encryption component 402, a passkey store 404, a key store 406, an interface 408, an authentication component 410, and core components 412. The interface 408 comprises an interface coupleable to one or more interconnects utilized by other electronic components, such as a bus, a switch, and the like. The passkey store 404 comprises a storage element (e.g., a register, a read-only memory (ROM), a flash memory, etc.) to store a passkey. The key store 408 comprises a storage element to store a set of keys for use by the encryption module 402 for encryption and decryption purposes. In one embodiment, the key store 408 includes the passkey store 404.

The core components 412 comprise the components of the electronic module 400 that provide functionality not directly related to the authentication process. For example, the electronic module 400 could include a processor and the core components could include, for example, a central processing unit (CPU), a north bridge, a south bridge, peripheral components, memory, and the like. In at least one embodiment, the core components 412 includes an input to receive an authentication flag 414, wherein the state of the authentication flag 414 can be represented by a single bit value (e.g., a particular voltage level) or a set of bits or a bit vector. The core components 412, in one embodiment, are configured to enable or disable one or more functions provided by the core components 412 based on the state of the authentication flag 414.

The encryption component 402 is coupled to the interface 408, the passkey store 404, the key store 408, the core components 412, and the authentication module 410. Based on configuration information from the authentication module 410 and other components of the electronic module 400, the encryption component 402 is configured to operate in an encryption mode, a decryption mode, and a clear mode. In the encryption mode, the encryption component 402 encrypts data from the electronic module 400 (e.g., data from the core components 412 or a passkey from the passkey store 404) using an identified key from the key store 406 and provides the encrypted result for output for transmission by the interface 408. In the decryption mode, the encryption component 402 is configured to receive data from another electronic module via the interface 408, apply a selected key from the key store 406 to decrypt the received data, and provide the results to the core components 412, the authentication module 410, or both. In a clear mode, the encryption module 402 provides data from the core components 412 to the interface 408 for transmission without encryption and provides data from the interface 408 to the core components 412 without decryption. Alternately, the interface 408 can be configured to provide unencrypted data from other electronic modules to the core components 412 directly without passing through the encryption module 402. In at least one embodiment, the mode of operation of the encryption module 402 is configured based on the state of the authentication flag 414. To illustrate, when the authentication flag 414 has a first state indicating that another electronic module remains unauthenticated, the encryption module 402 is be prevented from entering the clear mode with respect to the unauthenticated electronic module. Conversely, when the authentication flag 414 has a second state indicating that the electronic module has been authenticated, the encryption module 402 may enter the clear mode with respect to the authenticated electronic module.

The authentication module 410 includes an input to receive the passkey from the passkey store 404, an input to receive decrypted data from the encryption module 402, an output to provide configuration information for the encryption module 402, and output to provide the authentication flag 414. In operation, the authentication module 410 is configured to direct the encryption module 402 to generate a challenge using the passkey from the passkey store 404 and a key from the key store 406. Likewise, the authentication module 410 is configured to direct the encryption module 402 to decrypt a corresponding response using the correspond key from the key store 406. The authentication module 410 further is configured to compare the decrypted response with the passkey from the passkey store 404 to determine the degree to which these two values match. If there is a sufficient match, the authentication module 410 asserts the authentication flag 414 or places the authentication flag 414 in a state indicating that an electronic module has been authenticated. Otherwise, the authentication module 410 maintains the authentication flag 414 in an unasserted state or other state indicating the electronic module has not been authenticated. As discussed above, certain functionality of the core components 412 or the encryption component 402 can be enabled or disabled based on the state of the authentication flag 414.

FIG. 5 illustrates an example method 500 for encryption-based authentication of an electronic module in accordance with at least one embodiment of the present disclosure. For ease of illustration, the method 500 is described in the example context of the electronic component 400 of FIG. 4.

At block 502 a reset signal, a power-on signal, or other initiation stimulus is received at the electronic module 400. At block 504, the electronic module 400 initiates the encryption-based authentication process in response to the event received at block 502. To initiate the authentication process, the encryption component 402 encrypts a passkey obtained from the passkey store 404 and provides the encrypted passkey for transmission as a challenge via the interface 408 to another electronic module. If the other electronic module is likewise configured to implement the authentication process, the other electronic module decrypts the challenge, reencrypts the results, and transmits the encrypted results as a response to the electronic module 400. The electronic module 400 decrypts the response using a key from the key store 406 and provides the decrypted results to the authentication module 410. The authentication module 410 compares the decrypted results with the original passkey. In the event that the electronic module 400 and the other electronic module were configured to interoperate, they each would have been configured with compatible keys and thus decrypted results should match the original key. Otherwise, if the other electronic module was not intended for operation with the electronic module 400 and thus was not configured with compatible keys, the decrypted results would not match the original key (except by improbable coincidence).

Accordingly, at block 506 the authentication module 410 determines whether to authenticate the other electronic module based on whether the decrypted result matches the original passkey. If there is a sufficient match, the other electronic module is identified as authenticated and the authentication module 410 asserts the authentication flag 414. In response to authenticating the other electronic module (as represented by the asserted authentication flag 414), at block 508 the core components 412 can enable (or alternately disable) certain functionality. For example, the electronic module 400 may be configured to maintain one or more of the core components 412 in a stand-by state until authentication is confirmed. As another example, the electronic module 400 may be configured to prevent the encryption module 402 from entering a clear mode until authentication is confirmed.

In the event that there is not a sufficient match, the other electronic module is identified as not authenticated and the authentication module 410 maintains the authentication flag 414 in an unasserted state. In response to a failure to authenticate the other electronic module (as represented by the unasserted authentication flag 414), at block 510 the core components 412 can disable (or alternately enable) certain functionality. For example, the core components 412 can remain in a stand-by mode, the encryption module 402 may remain in an encryption/decryption mode, and the like.

As discussed above, the other electronic module can be authenticated based on a comparison of the decrypted results of its response with the original passkey. However, in other instances the other electronic module may not be configured to respond the challenge and thus the electronic module 400 will not receive a response. In these circumstances, the authentication module 410 can identify the other electronic module as not authenticated at block 508 when a response from the other electronic module is not received within a certain time frame from the transmission of the challenge.

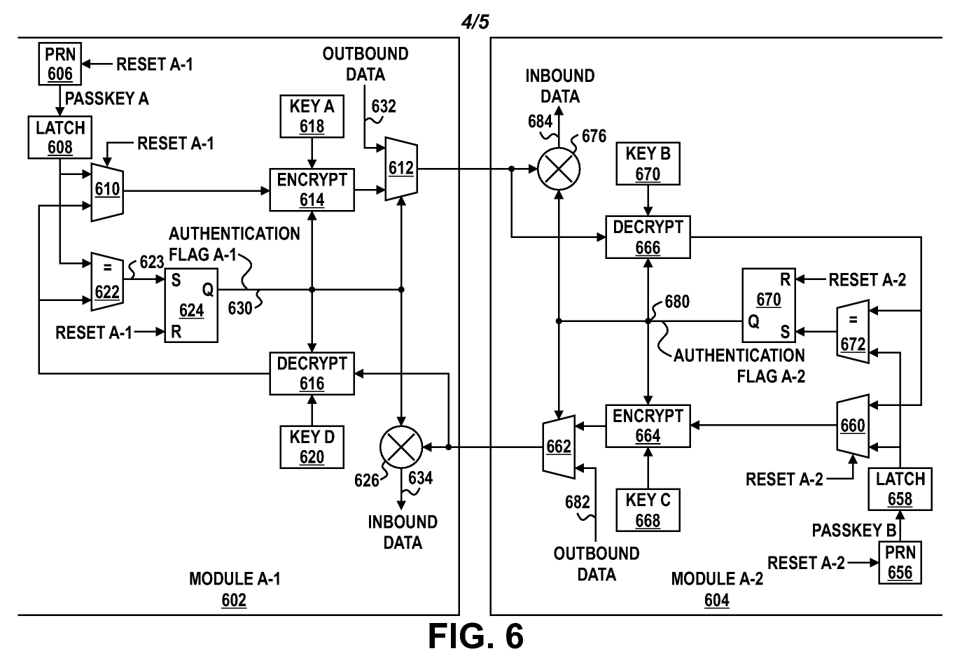

FIG. 6 illustrates an example electronic system comprising two electronic modules (electronic modules 602 and 604) using an encryption-based authentication process in accordance with at least one embodiment of the present disclosure. In the illustrated example, the electronic module 602 includes a passkey store implemented as a pseudo-random number (PRN) generator 606 and a latch 608, multiplexers 610 and 612, an encryption component 614, a decryption component 616, key stores 618 and 620, a comparator 622, an S-R latch 624, and a switch 626. The PRN generator 606 generates a pseudo-random number in response to an assertion of a reset A-1 signal representing a reset event, a periodic event, a power-on event, and the like. The latch 608 includes an input connected to the output of the PRN generator 606 and an output to provide the latched pseudo-random number as the passkey of the electronic module 602. The multiplexer 610 includes a first input connected to the output of the latch 608, a second input connected to the output of the decrypt module 616, and a select input to receive a value representative of the reset A-1 signal, whereby the multiplexer 610 selects the passkey for output in response to an assertion of the reset A-1 signal and selects the data output by the decrypt component 616 for output in response to an unassertion or deassertion of the reset A-1 signal. The encryption component 614 includes an input connected to the output of the multiplexer 610, an input connected to the key store 618, an input connected to receive an authentication flag A-1 630, and an output. The encryption component 614 is configured to encrypt the output of the multiplexer 610 using a key from the key store 618. Further, in the event that the authentication flag A-1 630 is unasserted (thereby indicating that the electronic module 604 is not authenticated), the encryption component 614 can be configured to remain in an encryption mode. The multiplexer 612 includes a first input connected to the output of the encryption component 614, a second input to receive outbound data 632 from core components (not shown) of the electronic module 602, a select input to receive the authentication flag 630, and an output. The multiplexer 612 selects the outbound data 632 for output to the electronic module 604 when the authentication flag 630 is asserted and selects the output of the encryption component 614 for output to the electronic module 604 when the authentication flag 630 is unasserted.

The switch 626 includes an input to receive data from the electronic module 604, an input to receive the authentication flag 630, and an output connected to the core components of the electronic module 602. In the event that the authentication flag A-1 630 is asserted, the switch 626 permits the incoming data to be passed to the core components as inbound data 634. Otherwise, if the authentication flag A-1 630 is unasserted, the switch 626 blocks the incoming data from being passed to the core components.

The decryption component 616 includes an input to receive data from the electronic module 604, an input from the key store 620, and an output connected to an input of the multiplexer 610 and to an input of the comparator 622. The decryption component 616 is configured to decrypt the incoming data using a key selected from the key store 620 and provide the decrypted results to the multiplexer 610 and the comparator 622. Further, the mode or state of the decryption component 616 can be controlled based on the state of the authentication flag A-1 630.

The comparator 622 includes a first input connected to the output of the latch 608, a second input connected to the output of the decryption component 616, and an output configured to provide a match indicator 623, whereby the comparator 622 is configured to assert the match indicator 623 when the value at the first input matches the value at the second input (i.e., the passkey matches the decrypted results from the decryption component 616) and is configured to maintain the match indicator 623 in an unasserted state when the two values do not match (i.e., decrypted results do not match the passkey). The S-R latch 624 includes a first input to receive the match indicator 623, a second input to receive the reset A-1 signal, and an output to provide the state of the match indicator 623 as the state of the authentication flag A-1 630 in response to an assertion of the reset A-1 signal.

The electronic module 604 is configured in a manner similar to the electronic module 602 and therefore includes a PRN generator 656, a latch 658, a multiplexer 660, a multiplexer 662, an encryption component 664, a decryption component 666, key stores 668 and 670, a comparator 672, an S-R latch 674, and a switch 676. The components of the electronic module 604 operate in the same manner as the corresponding components of the electronic module 602.

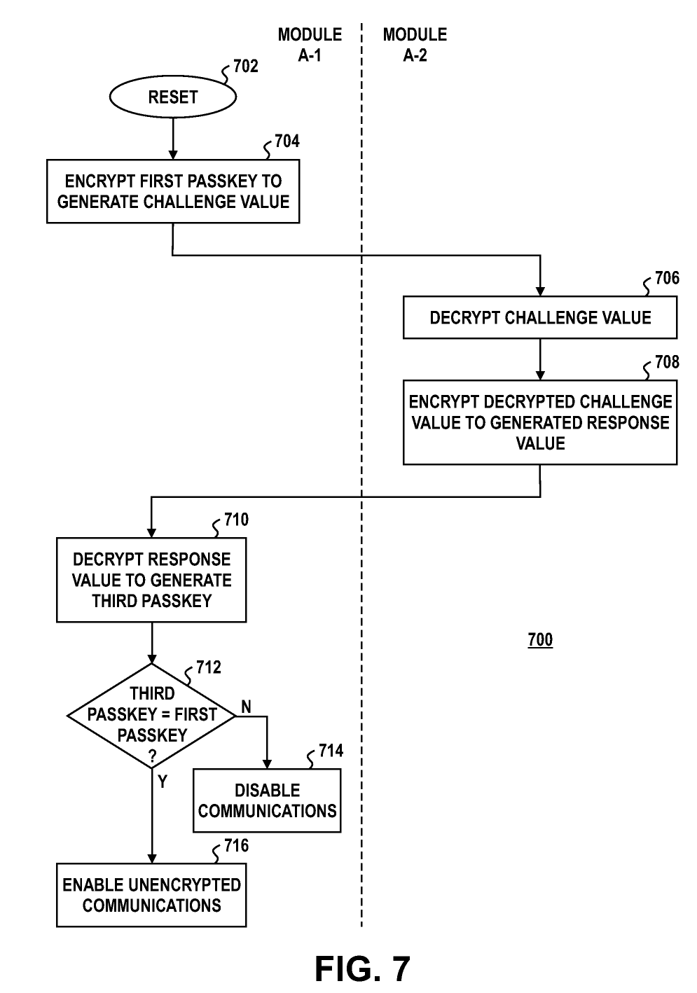

FIG. 7 illustrates an example method 700 of operation of the electronic system of FIG. 6. The method 700 details a process whereby the electronic module 602 authenticates the electronic module 604. This method can be used in a symmetrical manner for the authentication of the electronic module 602 by the electronic module 604.

At block 702, the reset A-1 signal 628 is asserted. The reset A-1 signal 628 triggers the PRN generator 606 to generate a first passkey, which is stored in the latch 608. Because the first passkey does not match the output of the decryption component 616 at this point (except by sheer coincidence), the match indicator 623 output from the comparator 622 is unasserted and thus the authentication flag A-1 630 remains unasserted by the S-R latch 624 when the reset A-1 signal is asserted.

At block 704, the passkey stored in the latch 608 is passed through the multiplexer 610 to the encryption component 614. The encryption component 614 encrypts the passkey using an encryption key A provided by the key store 618. The encrypted passkey is then selected to be output by the multiplexer 612 due to the unasserted state of the authentication flag 630, whereby the encrypted passkey is provided as a challenge value from the multiplexer 612 to the electronic module 604.

At block 706, the electronic module 604 receives the challenge value and the decryption component 666 decrypts the challenge value using a key B provided by the key store 670 to generate a second passkey. At block 708, the multiplexer 660 provides the second passkey to the encryption component 664 and the encryption component 664 encrypts the second passkey using a key C provided by the key store 668. The encrypted passkey is then provided from the encryption component 664 to the electronic module 602 as a response value via the multiplexer 662.

At block 710, the switch 626 provides the received response value to the decryption component 616, which decrypts the response value using a key D provided by the key store 620 to generate a third passkey. The third passkey is provided from the output of the decryption component 616 to the comparator 622. At block 712 the comparator 622 compare the first passkey stored at the latch 608 with the third passkey output from the decryption module 616. In the event there is not a sufficient match (meaning that key B was inconsistent with key A, key C was inconsistent with key D, or both), at block 714 the comparator 622 deasserts the match indicator 623, which causes the S-R latch 624 to maintain the authentication flag 630 at a deasserted state, thereby indicating that the electronic module 602 failed to authenticate the electronic module 604. In response to the deasserted state of the authentication flag 630, functionality of one or more of the core components 602 of the electronic module 620 can be disabled (or alternately enabled), in part to prevent operability with the electronic component 604. Further, the switch 626 remains in an unswitched state, thereby preventing inbound data 634 from being provided to the core components of the electronic module 602. Similarly, the multiplexer 612 remains configured to select data from the encryption component 614 rather than the outbound data 632 of the core components, thereby preventing outbound data 632 from reaching the electronic component 604.

Otherwise, if there is a sufficient match between the first passkey and the third passkey, at block the comparator 622 asserts the match indicator 623, which results in the assertion of the authentication flag 630 and thereby indicating that the electronic module 604 has been authenticated. In response to the authentication of the electronic module 604, at block 716 functionality of one or more core components is enabled (or alternately disabled) so as to facilitate communications with the electronic module 604. To illustrate, one or more of the core components can be switched from a stand-by mode to an operational mode. Further, the switch 626 can be activated so as to allow unencrypted communications from the electronic module 604 to pass to the core components of the electronic module 602 via inbound data 634. Likewise, the assertion of the authentication flag 630 causes the multiplexer 612 to select the unencrypted outbound data 632 from the core components of the electronic module 602 for transmission to the electronic module 604.

Substantially simultaneously to, independent of, prior to, or after, the authentication of electronic module 604 by electronic module 602, electronic module 604 can initiate the authentication process with electronic module 602 in a manner analogous to the authentication process described at FIG. 7. The outcome, if the authentication process is successful for both modules, is mutual authentication.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

What is claimed is:

1. A method comprising:
authenticating, at a first electronic module, a second electronic module via encrypted communications between the first electronic module and the second electronic module;
in response to determining the second electronic module is authenticated, configuring the first electronic module to conduct unencrypted communications with the second electronic module; and
in response to determining the second electronic module is unauthenticated, configuring the first electronic module to disable at least a first functionality of the first electronic module.

2. The method of claim 1, wherein authenticating the second electronic module comprises:
encrypting, at the first electronic module, a first passkey value using a first encryption key value to generate an encrypted challenge value;
providing the first encrypted challenge value for receipt by the second electronic module;
receiving, at the first electronic module, a response value from the second electronic module;
decrypting the response value using a second encryption key value to generate a second passkey value;
identifying the second electronic module as authenticated in response to determining the second passkey value matches the first passkey value; and
identifying the second electronic module as unauthenticated in response to determining the second passkey value does not match the first passkey value.

3. The method of claim 2, wherein authenticating the second electronic module further comprises:
receiving, at the second electronic module, the encrypted challenge value;
decrypting, at the second electronic module, the encrypted challenge value using a third key value to generate a third passkey value;
encrypting, at the second electronic module, the third passkey value using a fourth key value to generate the response value; and
providing the response value for receipt by the first electronic module.

4. The method of claim 3, wherein the first key value and the third key value comprise the same key value and the second key value and the fourth key value comprise the same key value.

5. The method of claim 3, wherein the first key value and the third key value comprise a first asymmetric encryption key value pair and the second key value and the fourth key value comprise a second asymmetric encryption key value pair.

6. The method of claim 1, further comprising:
authenticating, at the second electronic module, the first electronic module via the encrypted communications between the first electronic module and the second electronic module;
in response to determining the first electronic module is authenticated, configuring the second electronic module to conduct unencrypted communications with the first electronic module; and
in response to determining the first electronic module is unauthenticated, configuring the second electronic module to disable at least a first functionality of the second electronic module.

7. The method of claim 1, wherein configuring the first electronic module to disable the first functionality comprises configuring the first electronic module to disable communications with the second electronic module.

8. The method of claim 1, wherein configuring the first electronic module to disable at least the first functionality comprises configuring the first electronic module to a disabled state.

9. The method of claim 1, wherein authenticating the second electronic module comprises authenticating the second electronic module in response to a first reset event.

10. The method of claim 9, wherein disabling at least the first functionality of the first electronic module comprises disabling at least the first functionality of the first electronic module until a second reset event.

11. A method comprising:
manufacturing an electronic system comprising a plurality of electronic modules, the plurality of electronic modules collectively having a market value and each of the plurality of electronic modules configured to authenticate at least one other electronic module of the plurality of electronic modules via encrypted communications, and if authenticated, communicate with the at least one other electronic module via unencrypted communications, and if not authenticated, disable at least one functionality; and
providing the electronic system at a price less than the market value.

12. The method of claim 11, wherein manufacturing the electronic system comprises:
configuring each of the plurality of electronic modules to store a first key value and a second key value for the encrypted communications.

13. A system comprising:
a first electronic module comprising:
a first encryption component configured to:
encrypt a first passkey value to generate a first challenge value for transmission to a second electronic module; and
decrypt a first response value from the second electronic module to generate a second passkey value; and
a first authentication component configured to:
enable unencrypted communications with the second electronic module in response to determining the second passkey value matches the first passkey value; and
disable at least one functionality of the first electronic module in response to determining the second passkey value does not match the first passkey value.

14. The system of claim 13, wherein the first encryption component is configured to encrypt the first passkey value using a first key value and decrypt the first response value using a second key value different than the first key value.

15. The system of claim 13, wherein the first authentication component comprises a reset input and is configured to determine whether the second passkey value matches the first passkey value in response to a reset event at the reset input.

16. The system of claim 13, further comprising a second electronic module, the second electronic module comprising:
a second encryption component configured to:
decrypt the first challenge value to generate a third passkey value; and
encrypt the third passkey value to generate the first response value.

17. The system of claim 16, wherein:
the first encryption component is configured to encrypt the first passkey value using a first key value and decrypt the first response value using a second key value different than the first key value; and
the second encryption component is configured to decrypt the first challenge value using the first key value and encrypt the second passkey value using the second key value.

18. The system of claim 16, wherein:
the first encryption component is configured to encrypt the first passkey value using a first key value of a first asymmetrical encryption key pair and decrypt the first response value using a first key value of a second asymmetrical encryption key pair; and
the second encryption component is configured to decrypt the first challenge value using a second key value of the first asymmetrical encryption key pair and encrypt the second passkey value using a second key value of the second asymmetrical encryption key pair.

19. The system of claim 16, wherein the second electronic module further comprises a second authentication component, and wherein:
the second encryption component is configured to:
encrypt a fourth passkey value to generate a second challenge value for transmission to the first electronic module; and
decrypt a second response value from the first electronic module to generate a fifth passkey value; and
the second authentication component is configured to:
enable unencrypted communications with the first electronic module in response to determining the fifth passkey value matches the fourth passkey value; and
disable at least one functionality of the second electronic module in response to determining the fifth passkey value does not match the fourth passkey value; and
the first encryption component is configured to:
decrypt the second challenge value to generate a sixth passkey value; and
encrypt the sixth passkey value to generate the second response value.

20. The system of claim 13, wherein the system comprises a processor motherboard.
